(19) United States
(12) Patent Application Publication
(10) Pub. No.: US 2002/0120052 A1
(43) Pub. Date: Aug. 29, 2002

(54) Quaterpolymers with functional hydroxyl or epoxy groups

(76) Inventors: Peter Wendling, Leverkusen (DE); Lothar Reif, Dormagen (DE); Jurgen Trimbach, Koln (DE); Adrian Rawlinson, Leverkusen (DE); Rolf Peter, Dormagen (DE); Rudiger Engehausen, Dormagen (DE)

Correspondence Address: BAYER CORPORATION, PATENT DEPARTMENT, 100 BAYER ROAD, PITTSBURGH, PA, 15205, US

(21) Appl. No.: 09/998,498

(22) Filed: Nov. 30, 2001

(30) Foreign Application Priority Data
Dec. 4, 2000 (DE) 10060222.3

(51) Int. Cl. C08F 24/00; C08F 224/00; C08F 36/00; C08F 120/44; C08K 3/04

(52) U.S. Cl. 524/495; 526/266; 526/335; 526/341

(57) ABSTRACT

The invention relates to quaterpolymers based on conjugated dienes, vinyl-substituted aromatic compounds, olefinically unsaturated nitrites and monomers containing hydroxyl or epoxy groups. The rubber vulcanized products or molded parts, in particular tires, produced from the quaterpolymers and/or their mixtures with other rubbers are characterized by good mechanical properties, in particular by a favorable balance as regards the rolling resistance, antiskid resistance in the wet, and abrasion resistance, which is particularly advantageous for example, in tire manufacture.

### FIELD OF THE INVENTION

The invention relates to functionalized quaterpolymers based on conjugated dienes, vinyl-substituted aromatic compounds, olefinically unsaturated nitrites and monomers containing hydroxyl groups or epoxy groups, their production, their use in rubber mixtures, as well as their use for the production of all types of rubber molded parts.

### BACKGROUND OF THE INVENTION

Rubber mixtures are used for the production of rubber products intended for a very wide range of applications. Depending on the area of use, the corresponding rubber mixture has to satisfy different requirements. Thus, for example, the rubber mixture contains, apart from the rubber components, further constituents such as, for example, fillers, anti-aging agents and vulcanizing agents that substantially influence the properties of the end rubber product. The fillers, in particular, are especially important. Only an appropriate combination of rubbers and fillers and optionally, further constituents lead to optimum results in terms of target objectives. A development objective in recent years in the tire sector was the improvement of the rolling resistance, i.e. saving of fuel for economic and ecological reasons. At the same time, adverse effects on tire wear and anti-skid resistance in the wet should be avoided. Vulcanized products based on carbon black exhibit good mechanical properties, although a high rolling resistance and a poor anti-skid resistance in the wet are observed in mixtures used for tire treads. The use of silicic acid and filler activators such as, for example, bis-3-(triethoxysilylpropyl)tetrasulfide in combination with a styrene-butadiene rubber solution component and optionally, other rubbers led to tread mixtures having a low rolling resistance and good antiskid resistance in the wet. In the course of this development, the property profile of styrene-butadiene rubber solutions for use in silicic acid mixtures was optimized. Styrene-butadiene rubber emulsions cannot achieve this property profile with regard to silicic acid mixtures.

It is known that rubbers containing hydroxyl groups have an improved green strength. For example, U.S. Pat. No. 4,574,140 discloses the improvement of the green strength of terpolymers consisting of butadiene, styrene and hydroxyl group-containing monomers by using, in particular, crosslinking agents such as methylene-bis-(4-phenyldiisocyanate) and 4,4-diaminodiphenyl disulfide. U.S. Pat. No. 4,150,014 describes terpolymers of butadiene and acrylonitrile or butadiene and styrene with hydroxyl group-containing monomers in silicic acid mixtures. U.S. Pat. No. 4,357,432 describes mixtures of ethylene-styrene-butadiene rubbers and terpolymers containing butadiene, styrene and monomers containing hydroxyl groups or epoxy groups, together with fillers such as silicic acid or calcium silicate and carbon black. A low rolling resistance and improved strength under dynamic loading are mentioned as advantages.

EP-A 0 806 452 describes hydroxyl group-containing diene rubbers. The terpolymers also described there consist of butadiene, styrene and hydroxyl-group containing monomers and are characterized by a low rolling resistance and abrasion strength compared to ethylene-styrene-butadiene rubbers.

EP-A 0 819 731 discloses, for terpolymers produced in emulsion and consisting of amino group-containing monomers, butadiene and styrene, advantages in silicic acid mixtures regarding the rolling resistance and abrasion, compared to ethylene-styrene-butadiene rubbers. The same advantages are shown in EP-A 0 849 321, in which the vulcanization accelerator is a sulfenamide compound. EP-A 0 926 192 discloses, for terpolymers produced in emulsion and consisting of vinylpyridine, butadiene and styrene, advantages in silicic acid mixtures with respect to the rolling resistance and abrasion, compared to ethylene-styrene-butadiene rubbers. EP-A 1 081 162 describes terpolymers which consist of amino-group-containing or hydroxyl-group-containing monomers, butadiene and styrene having low heat build-up and which contain end groups of the kind resulting from the use of a chain transfer agent (tert.-DDM) [cf. Ullmanns Encyklopädie der technischen Chemie (Ullmann's Encyclopedia of Industrial Chemistry), 4th Edition, Vol. 23, (1983), pp. 182 et seq., Verlag Chemie GmbH, Weinheim]. Although the terpolymers disclosed in the aforementioned European patent publications have an improved rolling resistance and abrasion compared to ethylene-styrene-butadiene rubbers, nevertheless, these two parameters are still unsatisfactory, as is the important property of antiskid resistance in the wet. DE-A 196 43 035 describes terpolymers containing butadiene, styrene and acrylonitrile. These polymers are distinguished by good antiskid resistance in the wet, although the balance between the most important tire properties requires improvement.

### SUMMARY OF THE INVENTION

Accordingly, the object of the present invention is to provide rubbers that have a more favorable balance with respect to rolling resistance, antiskid resistance in the wet, and abrasion resistance.

It has now been found that functionalized quaterpolymers based on conjugated dienes, vinylaromatic compounds, olefinically unsaturated nitrites and monomers containing hydroxyl groups or epoxy groups have an improved property profile with regard to the aforementioned parameters.

Accordingly, the invention provides quaterpolymers comprising

a) 40 to 95 wt. % of a conjugated diene,

b) 1 to 30 wt. % of a vinyl-substituted aromatic compound,

c) 1 to 30 wt. % of an olefinically unsaturated nitrile, and

d) 0.1 to 20 wt. % of a vinyl monomer containing hydroxyl groups or epoxy groups, the components a) to d) in each case totaling 100 wt. %.

### DETAILED DESCRIPTION OF THE INVENTION

Preferred quaterpolymers contain 50 to 90 wt. %, preferably 55 to 85 wt. % of a conjugated diene; 5 to 30 wt. %, preferably 10 to 30 wt. % of a vinyl-substituted aromatic compound; 5 to 30 wt. %, preferably 10 to 25 wt. % of an olefinically unsaturated nitrile; as well as 0.5 to 15 wt. %, particularly preferably 1 to 10 wt. %, and in particular 1 to 6 wt. %, of a monomer containing hydroxyl groups or epoxy groups.

Conjugated dienes, which are preferably used according to the present invention, are conjugated dienes with 4 to 8 C atoms, for example 1,3-butadiene, isoprene, chloroprene, 1,3-pentadiene, 2,3-dimethyl-1,3-butadiene, 2-methyl-1,3-pentadiene and 2,3-dimethyl-1,3-pentadiene as well as mixtures thereof. 1,3-butadiene and isoprene are preferably used, 1,3-butadiene being most preferred.

Vinyl-substituted aromatic compounds, which are used, are those with 8 to 12 carbon atoms, for example, styrene, α-methylstyrene, p-methylstyrene, 1-vinyl-naphthalene, p-chlorostyrene as well as p-bromostyrene. Styrene is preferably used. Obviously, the vinyl-substituted aromatic compounds may be used singly or in combination with one another.

Suitable olefinically unsaturated nitrites are those containing 3 to 6 carbon atoms, such as acrylonitrile, methacrylonitrile, 3-butenenitrile and 4-pentenenitrile. It is preferred to use acrylonitrile and methacrylonitrile, most preferably acrylonitrile. The aforementioned nitriles may also be used individually or in arbitrary mixtures with one another.

Suitable vinyl monomers containing hydroxyl or epoxy groups are all vinyl monomers polymerizable with the previously mentioned monomers and that contain at least one hydroxyl or epoxy group. The hydroxyl groups of the hydroxyl group-containing monomers may be primary, secondary or tertiary hydroxyl groups. The vinyl monomers containing hydroxyl groups or epoxy groups may be used alone or in combination with other vinyl monomers containing hydroxyl or epoxy groups.

The vinyl monomers containing hydroxyl or epoxy groups include, for example, unsaturated carboxylic acid monomers, vinyl ether monomers, aromatic vinyl monomers, vinyl ketone monomers, glycidyl acrylates and methacrylates, allyl and methallyl ethers, as well as cyclohexane monoxide. It is preferred to use unsaturated carboxylic acid monomers. The unsaturated carboxylic acid monomers such as acrylic acid, methacrylic acid, itaconic acid, fumaric acid and maleic acid may be present, for example, in the form of their esters, amines, as well as in the form of anhydrides. Hydroxyl group-containing acrylic acid esters and methacrylic acid esters are preferred.

The following are examples of suitable hydroxyl group-containing monomers: hydroxymethyl(meth)acrylate, 2-hydroxyethyl(meth)acrylate, 2-hydroxypropyl(meth)acrylate, 3-hydroxypropyl(meth)acrylate, 3-chloro-2-hydroxypropyl(meth)acrylate, 3-phenoxy-2-hydroxypropyl(meth)acrylate, glycerol mono(meth)acrylate, hydroxybutyl(meth)acrylate, 3-chloro-2-hydroxypropyl(meth)acrylate, hydroxyhexyl(meth)acrylate, hydroxyoctyl(meth)acrylate, hydroxymethyl(meth)acrylamide, 2-hydroxyethyl(meth)acrylamide, 2-hydroxypropyl(meth)acrylamide, 3-hydroxypropyl(meth)acrylamide, di-(ethylene glycol)itaconate, di-(propylene glycol)itaconate, bis-(2-hydroxypropyl)itaconate, bis-(2-hydroxyethyl)itaconate, bis-(2-hydroxyethyl)fumarate, bis-(2-hydroxyethyl)maleate, 2-hydroxyethyl vinyl ether, hydroxymethyl vinyl ketone, glycidyl(meth)acrylate and allyl alcohol. Preferred are hydroxymethyl(meth)acrylate, 2-hydroxyethyl(meth)acrylate, 2-hydroxypropyl(meth)acrylate, 3-hydroxypropyl(meth)acrylate, 3-phenoxy-2-hydroxypropyl(meth)acrylate, glycerol mono(meth)acrylate, hydroxybutyl(meth)acrylate, hydroxyethyl(meth)acrylate, hydroxyoctyl(meth)acrylate, hydroxymethyl(meth)acrylamide, 2-hydroxyethyl(meth)acrylamide, 2-hydroxypropyl(meth)acrylamide, 3-hydroxypropyl(meth)acrylamide and glycidyl methacrylate. Most preferred are hydroxymethyl(meth)acrylate, 2-hydroxy(meth)acrylate, 3-hydroxypropyl(meth)acrylate and glycidyl methacrylate. Such monomers containing hydroxyl groups are also described, for example, in EP-A 0 806 457, page 4, lines 18 to 38.

The production of the quaterpolymers according to the present invention may, in principle, be carried out in solution, suspension or emulsion, production in emulsion being preferred.

Accordingly, the present invention also provides for the production of the quaterpolmers according to the present invention by polymerization of the aforementioned components in emulsion in a manner known per se.

Polymerization in emulsion may be carried out batchwise as well as continuously. Obviously, it is also possible to add the monomers to be used incrementally to the polymerization.

Emulsion polymerization may be carried out in the presence of anionic, cationic or non-ionic emulsifiers or mixtures thereof, such as are conventionally used for emulsion polymerization. The pH value is in the range from ca. 2 to 13 and is adjusted to the emulsifiers that are employed.

Suitable emulsifiers are, for example, salts of disproportionated resin acid, salts of unmodified resin acid, salts of fatty acids and fatty acid mixtures, alkylsulfonic, arylsulfonic and alkarylsulfonic acids and sulfates, and mixtures thereof.

In addition, in emulsion polymerization, there may be used known auxiliary substances such as salts, chain-transfer agents as well as complexing agents. Examples of suitable salts are phosphates, chlorides, carbonates and sulfides of metals, such as sodium phosphate, potassium chloride and sodium hydrogen carbonate. Examples of chain-transfer agents are mercaptans and xanthogene disulfides, such as tert.-dodecylmercaptan, diethylxanthogene disulfide and diisopropylxanthogene disulfide. Dodecyl mercaptans are preferred, tert.-dodecyl mercaptan is particularly preferred and tert.-dodecyl mercaptans derived from isobutene as a structural unit are very particularly preferred. An example of a readily available complexing agent is the sodium salt of ethylenediaminetetra-acetic acid.

Suitable initiators for the polymerization are the known, radical-donor compounds such as peroxides, hydrogen peroxide, persulfates and redox systems, such as hydroperoxide/sodium formaldehyde sulfoxylate/iron. When using iron, complex-forming agents such as the aforementioned sodium salt of ethylene-diaminetetraacetic acid may be beneficial. The redox system methane hydroperoxide/sodium formaldehyde sulfoxylate/iron/sodium salt of ethylenediamine tetraacetic acid is preferred.

The polymerization in emulsion may be carried out at temperatures in the range from 0 to 100° C., preferably 5 to 20° C. The monomers used are conventionally polymerized to a monomer conversion of 50 to 90 wt. %, preferably 60 to 80 wt. %, referred to the total amount of monomers that are used. After the desired monomer conversion has been achieved, the polymerization may be discontinued by using known terminators, for example, with the aid of cresols, diethylhydroxylamine, dithiocarbamates or sodium dithionite or mixtures thereof. In this connection, it may be helpful to add known anti-aging agents to the quaterpolymers that are obtained, for example, sterically hindered phenols as well as aminic and/or phosphidic anti-aging agents. The addition of such anti-aging agents preferably takes place in the latex stage. In addition, plasticizers and/or stretching oils may be added, likewise preferably at the latex stage.

The separation of the quaterpolymers according to the present invention from the latex is effected in known manner by coagulation, for example, by adding acids, salts or organic polyelectrolytes or mixtures thereof. The coagulation may also be initiated by lowering or raising the temperature and/or by application of shear forces.

After completion of the coagulation the quaterpolymer is separated, washed with water, optionally dehydrated in suitable apparatus, and then dried.

Such emulsion polymerization processes and the auxiliary substances used therefor are generally known and are described in more detail for example in Houben-Weyl, Methoden der organischen Chemie, Vol. 14/1, Georg Thieme Verlag, Stuttgart (1961); Ullmann's Encyclopedia of Industrial Chemistry, Vol. A23, Rubber, 3. Synthetic, VCH Verlagsgesellschaft mbH Weinheim (1993).

The quaterpolymers obtained according to the present invention have a Mooney viscosity of 20 to 150, preferably 30 to 120, measured according to DIN 53523, and a glass transition temperature (T_{G} value) in the range from −5 to −70° C., preferably −10 to −60° C. In addition, the quaterpolymers obtained according to the present invention have a gel content of 0.01 to 20%, preferably 0.01 to 10%, more preferably 0.01 to 3%.

The present invention also provides for the use of the quaterpolymers for the production of all types of molded parts, in particular for the manufacture of tires, tire components such as tire treads and tire side walls, as well as belts, hoses and seals. The quaterpolymers are most preferably used for the manufacture of tires and tire components.

Furthermore, the present invention provides rubber mixtures containing the quaterpolymers according to the present invention and other natural or synthetic rubbers or mixtures of natural or synthetic rubbers, as well as optionally fillers, other auxiliary substances that improve the properties of rubber, and also conventional crosslinking agents.

Preferred rubber mixtures are those that contain 5 to 90, preferably 10 to 80 parts by weight of the quaterpolymers according to the present invention, 10 to 95, preferably 20 to 90 parts by weight of natural or synthetic rubbers or mixtures of natural or synthetic rubbers, as well as 10 to 150, preferably 20 to 100 parts by weight of fillers.

As previously mentioned, the rubber mixtures according to the present invention may contain, in addition to natural rubber, also other synthetic rubbers, alone or in combination with one another, such as polybutadiene, polyisoprene, polychloroprene, styrene-butadiene copolymers, styrene-isoprene copolymers, isoprene-butadiene-styrene copolymers, acrylonitrile-butadiene copolymers, acrylonitrile-styrene-butadiene terpolymers, carboxylated acrylonitrile-butadiene copolymers, hydrogenated acrylonitrile-butadiene copolymers, or ethylene-propylene-diene terpolymers.

The mixing of the quaterpolymers according to the present invention with other rubbers may be effected by means of a mixing device such as a roller or a kneader. It is also possible to mix the quaterpolymers according to the present invention with other rubbers in the form of latices.

As previously mentioned, other conventional auxiliary substances that improve the properties of the rubbers, as well as conventional crosslinking agents, may be added to the rubber mixtures according to the present invention. Suitable additives in this connection are, for example, fillers, pigments, zinc oxide, stearic acid, vulcanization accelerators, anti-aging agents, plasticizers, waxes, extending oils, tackifying agents as well as plasticizing agents. The aforementioned additives are used in conventional amounts, which are known to the person skilled in the art and depend on the intended use.

Suitable vulcanization accelerators are, for example, amines, guanidines, thioureas, thiazoles, thiurams, dithiocarbamates, xanthogenates and sulfenamides. The amounts of accelerators are known to the person skilled in the art and depend on the intended use. Suitable crosslinking agents are for example elementary sulfur and sulfur donors such as polysulfides, for example, dithiocarbamates and thiuram polysulfides. The appropriate amounts are known to the person skilled in the art and depend on the intended use. Suitable anti-aging agents include phenols, bisphenols, thiobisphenols, polyphenols, hydroquinones, amines such as naphthylamines, diphenylamines, diarylamines, as well as phosphites. Conventional amounts of anti-aging agents are 0.1 to 10 parts by weight referred to the total amount of rubber.

Suitable fillers for the rubber mixtures according to the present invention are carbon blacks and silicic acids known per se, as well as silicates, titanium dioxide, chalk and clay. The fillers may be used singly as well as in combination with one another. The use of silicic acid is preferred.

Suitable carbon blacks are, for example, those that have been produced by the flame black, furnace black or gas black process and that have a BET surface of 20 to 200 m²/g. Examples are SAF, ISAF, HAF, FEF or GPB carbon blacks.

Suitable silicic acids are, for example, those having BET surfaces of ca. 30 to 270 m²/g.

When using silicic acids, so-called filler activators such as, for example, bis-3-(triethoxysilylpropyl)tetrasulfide may also be added to the rubber mixtures. The amount of such activators is normally ca. 2 to 20 wt. % referred to silicic acid.

The aforementioned additives and/or auxiliary substances are, as previously mentioned, known to the person skilled in the art, and likewise, the amounts to be used are also known and are described in, inter alia, Kautschuk-Technologie, lecture thesis submitted by Werner Hofmann to the Mechanical Engineering Department, Technische Hochschule Aachen 1975; Handbuch fur die Gummiindustrie published by Bayer AG Leverkusen).

The present invention, moreover, provides all types of rubber molded parts, in particular tires, tire components such as tire treads and side walls, belts, hoses as well as seals, which are characterized in that they are produced by using the aforementioned rubber mixtures in a shaping and forming procedure by means of a suitable vulcanization process.

In the following examples, the properties of the rubbers according to the present invention, the comparison rubbers and the resulting vulcanized products were measured as follows:

(1) The polymer composition was measured by means of ¹H-NMR.

(2) The Mooney viscosity of the rubbers was determined according to DIN 53523.

(3) The tensile strength of the vulcanized products was determined according to DIN 53504.

(4) The elongation at break of the vulcanized products was determined according to DIN 53504.

(5) The modulus of the vulcanized products at 100%, 200% and 300% elongation was determined according to DIN 53504.

(6) The hardness of the vulcanized products at 70° C. was determined according to DIN 53505.

(7) The abrasion of the vulcanized products was determined according to DIN 53516.

(8) The tan δ of the vulcanized products was determined according to DIN 53513.

(9) The gel content was determined in toluene as follows: 100 to 150 mg of the rubber were allowed to stand for 16 hours in 20 ml of toluene and were then shaken for 2 hours. After centrifuging off the insoluble fraction, the latter was dried, weighed, and specified as a percentage of the weighed amount of rubber.

### EXAMPLES

1. Production and Characterization of the Quaterpolymers According to the Present Invention

### Example 1

900 g of styrene, 14.63 g of tert.-dodecylmercaptan (produced by Bayer AG), 450.00 g of acrylonitrile, 112.50 g of glycidyl methacrylate and a solution consisting of 7970.09 g of completely demineralized water, 197.44 g of disproportionated resin acid (sodium salt, 70%), 2060.53 g of partially hydrogenated tallow fat acid (potassium salt, 9.5%), 14.06 g of potassium hydroxide (85%), 32.06 of condensed naphthalenesulfonic acid (Na salt) and 14.63 g of potassium chloride, as well as 4162.50 g of butadiene were placed in an evacuated, stirrable 20 I capacity steel reactor and kept at a temperature of 10° C. The polymerization was started by adding 2.43 g of p-methane hydroperoxide (50%) and a solution consisting of 268.65 g of completely demineralized water, 2.70 g of EDTA, 2.16 g of iron (II) sulfate .7 H₂O, 5.54 g of sodium formaldehyde sulfoxylate and 8.37 g of sodium phosphate .12 H₂O, and was continued at 10° C. while stirring.

The polymerization was stopped at a conversion of 83% by adding 22.5 9 of diethylhydroxylamine (25%) and 1.13 g of sodium dithionite. 13.50 g of Vulkanox® BKF (2,2′-methylene-bis-(4-methyl-6-tert.-butylphenol, product obtainable from Bayer AG Leverkusen) was added in the form of a 46% dispersion (29.35 g) to the latex. The unreacted butadiene was degassed and the unreacted monomers were removed by means of steam. 80 I of completely demineralized water (60° C.) were added to the degassed latex while stirring and the latex was precipitated at 60° C. by adding 100 parts by weight of sodium chloride and 0.25 part by weight of polyamine (Superfloc® C567) referred to rubber at pH 4 and under the addition of 10% sulfuric acid. The polymer obtained was filtered off and washed with completely demineralized water at 65° C. while stirring. The moist rubber was dried at 70° C. in a vacuum drying cabinet to a residual moisture content of <0.5%.

The Mooney viscosity of the resultant polymer was 62 (ME).

The polymers of Examples 2-4 according to the present invention were produced in a similar way. A summary of the monomer mixtures employed as well as the Mooney viscosity and gel content of the resultant polymers is given in Table 1.

TABLE 1

| | Example | Example | Example | Example | Example |
|---|---|---|---|---|---|
| Monomer | 1 | 2 | 3 | 4 | 5 |
| Butadiene (wt. %) | 74.00 | 74.00 | 74.00 | 74.00 | 55.00 |
| Styrene (wt. %) | 16.00 | 14.18 | 14.59 | 12.65 | 23.65 |
| Acrylonitrile (wt. %) | 8.00 | 8.00 | 8.00 | 8.00 | 16.00 |
| Glycidyl methacrylate (wt. %) | 2.00 | | | | |
| 2-hydroxyethyl methacrylate (wt. %) | | 3.82 | | | |
| 2-hydroxyethyl acrylate (wt. %) | | | 3.41 | | |
| 2-hydroxyethyl methacrylate (wt. %) | | | | 5.35 | |
| 2-hydroxyethyl methacrylate | | | | | 5.35 |
| Total monomers (wt. %) | 100 | 100 | 100 | 100 | 100 |
| Mooney viscosity (ME) | 62 | 56 | 78 | 56 | 43 |
| Gel content in toluene | 1.8 | 2.2 | 1.5 | 3.4 | 1.4 |
| (%) | | | | | |

The polymer composition, with the exception of the acrylonitrile content, was determined by means of ¹H-NMR. The acrylonitrile content was determined by nitrogen determination. The results are summarized in Table 2.

TABLE 2

| | Example | Example | Example | Example | Example |
|---|---|---|---|---|---|
| | 1 | 2 | 3 | 4 | 5 |
| 1,2-butadiene (wt. %) | 12.3 | 12.2 | 12.5 | 12.5 | 8.5 |
| 1,4-butadiene (wt. %) | 63.1 | 64.0 | 64.8 | 63.5 | 50.2 |
| Styrene (wt. %) | 12.7 | 10.0 | 11.5 | 11.2 | 17.8 |
| Acrylonitrile (wt. %) | 9.5 | 9.7 | 9.8 | 9.6 | 19.6 |
| Glycidyl methacrylate (wt. %) | 2.4 | | | | |
| 2-hydroxyethyl methacrylate (wt. %) | | 4.1 | | | |
| 2-hydroxyethyl acrylate (wt. %) | | | 1.4 | | |
| 2-hydroxyethyl methacrylate (wt. %) | | | | 3.2 | |
| 2-hydroxyethyl methacrylate | | | | | 3.9 |
| Total (wt. %) | 100.0 | 100.0 | 100.0 | 100.0 | 100 |

2. Comparison Examples

Comparison example 1 is a styrene-butadiene copolymer produced in solution (Buna VSL 5025-0, vinyl content 50%, styrene content 25%, manufacturer Bayer Elastomeres).

Comparison example 2 is a styrene-butadiene copolymer produced in emulsion (Krylene® 1500, styrene content 23.5%, manufacturer Bayer Elastomeres).

Comparison example 3 was produced corresponding to the rubbers according to the invention, a monomer mixture consisting of 74 wt. % of butadiene, 18 wt. % of styrene and 8 wt. % of acrylonitrile being used. The Mooney viscosity of the rubber is 78 ME. The polymer composition was determined by means of ¹H-NMR (12.7% 1,2-butadiene, 64.3% 1,4-butadiene, 14.2% styrene, 8.8% acrylonitrile). This example represents the prior art according to DE-A 196 43 035.

Comparison example 4 was produced corresponding to the rubbers according to the invention, a monomer mixture consisting of 71 wt. % of butadiene, 23.65 wt. % of styrene and 5.35 wt. % of 2-hydroxyethyl methacrylate being used. The Mooney viscosity of the rubber is 60 ME. The polymer composition was determined by means of ¹H-NMR (12.2% 1,2-butadiene, 65.1% 1,4-butadiene, 18.6% styrene, 4.1% 2-hydroxyethyl methacrylate). This example represents the prior art according to EP-A 1 081 162.

Comparison Example 5 is a rubber of the kind described in EP-A 0 926 192 and EP-A 0 819 731. The production was carried out by emulsion polymerization corresponding to the rubbers according to the present invention, a monomer mixture consisting of 71 wt. % of butadiene, 24.96 wt. % of styrene and 4.04 wt. % of 2-vinylpyridine being used. The Mooney viscosity of the rubber is 68 ME. The polymer composition was determined by means of ¹H-NMR (12.4% 1,2-butadiene, 63.9% 1,4-butadiene, 19.5% styrene, 4.2% vinylpyridine).

3. Testing of the Polymers According to the Present Invention and the Comparison Polymers in Silicic Acid Mixtures.

The following mixture was used:

TABLE 3

| | |
|---|---|
| TSR 5, Defo 700 | 10 |
| Buna CB 25 | 30 |
| 3. Rubber | 60 |
| Vulkasil S | 70 |
| Silane Si 69 | 5.6 |
| Carbon Black Corax | 10 |
| N121 | |
| Enerthene 1849-1 | 37.5 |
| ZnO RS | 2.5 |
| Stearic Acid | 1 |
| Antilux 654 | 1.5 |
| Vulkanox HS | 1 |
| Vulkanox 4020 | 1 |
| Vulkacit CZ | 1.8 |
| Vulkacit D | 2 |
| Sulfur | 1.5 |

The rubbers according to the present invention and/or the comparison rubbers were used as “3. rubber”.

### Details of the Mixing Components Used

TSR 5, Defo 700 (natural rubber)

Buna® CB 25 (polybutadiene, manufacturer Bayer AG)

Vulkasil® S (activated silicic acid, product from Bayer AG)

Si 69 (bis-3-(triethoxysilylpropyl)tetrasulfide, manufacturer Degussa Hüls AG)

Corax® N121 (carbon black, manufacturer Degussa Hüls AG)

Enerthene 1849-1® (mineral oil/plasticizer, manufacturer Mobil Schmierstoff GmbH)

ZnO RS® (product from Bayer AG)

Antilux 654® (light protection wax, manufacturer Rheim-Chemie GmbH)

Vulanox® HS (polymerized 2,2,4-trimethyl-1,2-dihydroquinoline, manufacturer Bayer AG)

Vulkanox® 4020 (N-(1,3-dimethylbutyl)-N′-phenyl-p-phenylenediamine, manufacturer Bayer AG)

Vulkacit® CZ (N-cyclohexyl-2-benzothiazyl-sulfenamide, manufacturer Bayer AG)

Vulkacit® D (diphenylguanidine, manufacturer Bayer AG)

The following results were obtained:

TABLE 3

| | Compari- | | | |
|---|---|---|---|---|
| | son | | | |
| | Example | Example | Example | Example |
| Crude polymer | 1 | 1 | 2 | 3 |
| ML 1 + 4 (ME) | 51 | 62 | 56 | 78 |
| Vulcanized product | | | | |
| Tensile strength (Mpa) | 20.5 | 17 | 16.2 | 13.2 |
| Elongation at break (%) | 620 | 440 | 385 | 325 |
| Modulus 100 (Mpa) | 2.1 | 2.4 | 2.5 | 2.8 |
| Modulus 200 (Mpa) | 4.4 | 5.8 | 6.4 | 6.8 |
| Hardness 70° C. (Shore | 67 | 67 | 66 | 68 |
| A) | | | | |
| DIN abrasion 60 (mm³) | 90 | 95 | 85 | 65 |
| Index tan δ 0° C. | 100 | 107 | 100 | 92 |
| Index tan δ 60° C. | 100 | 116 | 115 | 117 |
| Index > 100 = | | | | |
| better | | | | |

The index values for the tan δ values at 0° C. and 60° C. in the above and the following tables were determined as follows:

$$Index tan δ at {0}^{∘} C . = \frac{\begin{matrix}tan value of the example \\ according to the invention \times 100\end{matrix}}{tan value of the comparison example}$$

$$Index tan δ at {60}^{∘} C . = \frac{tan value of the comparison example \times 100}{\begin{matrix}tan value of the example \\ according to the invention\end{matrix}}$$

The person skilled in the art knows that a high tan δ value at 0° C. denotes a good antiskid resistance in the wet, while a low tan δ value at 60° C. represents a low rolling resistance. As Table 3 shows, the rubbers according to the present invention have advantages compared to a styrene-butadiene rubber produced in solution as regards rolling resistance (tan δ 60° C.) at comparable hardness. Depending on the nature of the quatermonomers, the rubbers according to the present invention in addition also exhibit advantages as regards the antiskid resistance in the wet (tan δ 0° C.) or the abrasion resistance.

TABLE 4

| | Compari- | | | |
|---|---|---|---|---|
| | son | | | |
| | Example | Example | Example | Example |
| Crude polymer | 2 | 1 | 2 | 3 |
| ML 1+ 4 (ME) | 49 | 62 | 56 | 78 |
| Vulcanized product | | | | |
| Tensile strength (Mpa) | 19.8 | 17 | 16.2 | 13.2 |
| Elongation at break (%) | 615 | 440 | 385 | 325 |
| Modulus 100 (Mpa) | 2.1 | 2.4 | 2.5 | 2.8 |
| Modulus 200 (Mpa) | 4.4 | 5.8 | 6.4 | 6.8 |
| Hardness 70° C. (Shore | 64 | 67 | 66 | 68 |
| A) | | | | |
| DIN abrasion 60 (mm³) | 100 | 95 | 85 | 65 |
| lndex tan δ 0° C. | 100 | 91 | 85 | 79 |
| lndex tan δ 60° C. | 100 | 121 | 120 | 123 |
| Index > 100 = better | | | | |

It can be seen from Table 4 that the rubbers according to the present invention are superior to an ethylene-styrene-butadiene rubber as regards the properties of rolling resistance (tan δ 60° C.) and abrasion.

TABLE 5

| | | Comparison | |
|---|---|---|---|
| | | Example 3 | Example 2 |
| Crude polymer | | | |
| ML 1 + 4 | (ME) | 69 | 56 |
| Vulcanized product | | | |
| Tensile strength | (Mpa) | 20.1 | 16.2 |
| Elongation at break | (%) | 475 | 385 |
| Modulus 100 | (Mpa) | 2.9 | 2.5 |
| Modulus 200 | (Mpa) | 7 | 6.4 |
| Hardness 70° C. | (Shore A) | 64 | 66 |
| DIN abrasion 60 | (mm³) | 95 | 85 |
| Index tan δ 0° C. | | 100 | 94 |
| Index tan δ 60° C. | | 100 | 103 |
| Index > 100 = better | | | |

Comparison with a butadiene-styrene-acrylonitrile terpolymer shows that the rubber according to the present invention is superior as regards the properties of rolling resistance (tan δ 60° C.) and abrasion (Table 5).

TABLE 6

| | | Comparison | |
|---|---|---|---|
| | | Example 4 | Example 4 |
| Crude polymer | | | |
| ML 1 + 4 | (ME) | 60 | 56 |
| Vulcanized product | | | |
| Tensile strength | (Mpa) | 13.2 | 12.2 |
| Elongation at break | (%) | 340 | 265 |
| Modulus 100 | (Mpa) | 2.6 | 3.7 |
| Modulus 200 | (Mpa) | 6.1 | 8.5 |
| Hardness 70° C. | (Shore A) | 73 | 73 |
| DIN abrasion 60 | (mm³) | 100 | 75 |
| Index tan δ 0° C. | | 100 | 88 |
| Index tan δ 60° C. | | 100 | 109 |
| Index > 100 = better | | | |

Comparison with a terpolymer consisting of butadiene, styrene and 2-hydroxymethacrylate shows that the rubber according to the present invention is superior as regards the properties of rolling resistance (tan δ 60° C.) and abrasion (Table 6).

TABLE 7

| | | Comparison | |
|---|---|---|---|
| | | Example 5 | Example 3 |
| Crude polymer | | | |
| ML 1 + 4 | | 68 | 78 |
| Vulcanized product | | | |
| Hardness 70° C. | (Shore A) | 65 | 68 |
| DIN abrasion 60 | (mm³) | 85 | 65 |
| Index tan δ 0° C. | | 100 | 98 |
| Index tan δ 60° C. | | 100 | 116 |
| Index > 100 = better | | | |

A comparison with ethylene-styrene-butadiene rubbers containing 2-vinylpyridine shows that the rubber according to the present invention is superior to the rubber produced corresponding to EP-A 0 926 192 and EP-A 0 819 731 as regards the properties of abrasion and rolling resistance (tan δ 60° C.) at comparable hardness (Table 7).

Example 5 was tested in the following mixture:

| | | |
|---|---|---|
| SBR 1500 | 100 | 80 |
| Rubber according to | 0 | 20 |
| the invention | | |
| Vulkasil S | 50 | 50 |
| Si 69 | 6 | 6 |
| Aromatic oil | 20 | 20 |
| Stearic acid | 2 | 2 |
| Zinc oxide | 3 | 3 |
| Vulkanox 4010 NA | 1 | 1 |
| Vulkanox 4020 | 1 | 1 |
| Sulfur | 2 | 2 |
| Vulkacit CZ | 1.5 | 1.5 |
| Vulkacit D | 0.2 | 0.2 |

### Details of the Mixing Components Used

(Krylene® 1500, emulsion SBR, styrene content 23.5%, manufacturer Bayer Elastomeres).

Vulkasil® S (active silica, product from Bayer AG)

Si 69 (bis-3-(triethoxysilylpropyl)tetrasulfide, manufacturer Degussa Hüls AG)

Renopal® 450 (aromatic mineral oil/plasticizer, manufacturer Fuchs Chemie)

ZnO RS® (product from Bayer AG)

Vulkanox® 4010 Na (N-isopropyl-N′-phenyl-p-phenylenediamine, manufacturer Bayer AG)

Vulkanox® 4020 (N-(1,3-dimethylbutyl)-N′-phenyl-p-phenylenediamine, manufacturer Bayer AG)

Vulkacit® CZ (N-cyclohexyl-2-benzothiazyl-sulfenamide, manufacturer Bayer AG) p0 Vulkacit® D (diphenylguanidine, manufacturer Bayer AG)

The results are summarized in Table 8.

TABLE 8

| | | Comparison | |
|---|---|---|---|
| | | example 2 | Example 5 |
| Crude polymer | | | |
| ML 1 + 4 | (ME) | 49 | 43 |
| Vulcanized product | | | |
| Tensile strength | (Mpa) | 26.1 | 19.6 |
| Elongation at break | (%) | 580 | 475 |
| Modulus 100 | (Mpa) | 2.1 | 2.4 |
| Modulus 200 | (Mpa) | 5.0 | 5.2 |
| Hardness 70° C. | (Shore A) | 57 | 61 |
| DIN abrasion 60 | (mm³) | 80 | 83 |
| Index tan δ 0° C. | | 100 | 145 |
| Index tan δ 60° C. | | 100 | 92 |
| Index > 100 = better | | | |

The results in Table 8 show that in the rubbers according to the invention the components butadiene, styrene and acrylonitrile can be widely varied. Example 5 according to the invention is considerably superior to the prior art as regards the antiskid resistance in the wet (tan δ 0° C.), while the abrasion is comparable and the rolling resistance (tan δ 60° C.) is slightly higher.

4. Tests in Carbon Black Mixtures

The following mixture was used

| | |
|---|---|
| Krynol 172 | 68.75 |
| 2. Rubber | 50 |
| Renopal 450 | 18 |
| Carbon Black N339 | 77 |
| ZnO | 3 |
| Stearic Acid | 1.5 |
| Vulkanox 4020 | 2.5 |
| Vulkanox HS | 1.5 |
| Vulkacit NZ | 1.2 |
| Sulfur | 1.5 |

The rubbers according to the present invention and/or the comparison rubbers were used as “2. rubber”.

### Details Concerning the Mixture Components Used

Krynol® 1712 ( styrene-butadiene rubber emulsion, 23.5% styrene, 37.5% highly aromatic mineral oil, manufacturer Bayer Elastomeres)

Renopal® 450 (aromatic mineral oil/plasticizer, manufacturer Fuchs Chemie)

Corax® N 339 (carbon black, manufacturer Degussa Hüls AG) ZnO

Vulkanox® 4020 (N-(1,3-dimethylbutyl)-N′-phenyl-p-phenylenediamine, manufacturer Bayer AG)

Vulkanox® HS (polymerized 2,2,4-trimethyl-1,2-dihydroquinoline, manufacturer Bayer AG)

Vulkacit® NZ (N-tert.butyl-benzothiazyl-sulfenamide, manufacturer Bayer AG)

TABLE 9

| | Compari- | | | |
|---|---|---|---|---|
| | son | | | |
| | Example | Example | Example | Example |
| Crude polymer | 2 | 1 | 2 | 3 |
| ML 1 + 4 at 100° C. | 49 | 62 | 56 | 78 |
| Vulcanized product | | | | |
| Tensile strength (Mpa) | 16.8 | 22.9 | 21.1 | 20.8 |
| Elongation at break (%) | 820 | 685 | 735 | 740 |
| Modulus 100 (Mpa) | 1.1 | 1.5 | 1.2 | 1.2 |
| Modulus 300 (Mpa) | 4.2 | 8 | 5.9 | 5.9 |
| Index tan δ 0° C. | 100 | 110 | 104 | 109 |
| Index tan δ 60° C. | 100 | 108 | 107 | 106 |
| Index > 100 = | | | | |
| better | | | | |

The results in Table 9 show that the rubbers according to the present invention are superior to a commercially available ethylene-styrene-butadiene rubber both as regards the antiskid resistance in the wet (tan δ 0° C.) and the rolling resistance (tan δ 60° C.).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. Quaterpolymers comprising
a) 40 to 95 wt. % of a conjugated diene,
b) 1 to 30 wt. % of a vinyl-substituted aromatic compound,
c) 1 to 30 wt. % of an olefinically unsaturated nitrite, and
d) 0.1 to 20 wt. % of a vinyl monomer containing hydroxyl groups or epoxy groups,
wherein the components a) to d) in each case total 100 wt. %.

2. A process for the production of the quaterpolymers, wherein said quaterpolymers comprise
a) 40 to 95 wt. % of a conjugated diene,
b) 1 to 30 wt. % of a vinyl-substituted aromatic compound,
c) 1 to 30 wt. % of an olefinically unsaturated nitrile, and
d) 0.1 to 20 wt. % of a vinyl monomer containing hydroxyl groups or epoxy groups,
wherein the components a) to d) in each case total 100 wt. %.
and the polymerization of the monomers a) to d) is carried out in emulsion.

3. Molded parts comprising quaterpolymers, which comprise
a) 40 to 95 wt. % of a conjugated diene,
b) 1 to 30 wt. % of a vinyl-substituted aromatic compound,
c) 1 to 30 wt. % of an olefinically unsaturated nitrile, and
d) 0.1 to 20 wt. % of a vinyl monomer containing hydroxyl groups or epoxy groups,
wherein the components a) to d) in each case total 100 wt. %.

4. Rubber mixtures comprising quaterpolymers and other natural or synthetic rubbers or mixtures of natural or synthetic rubbers as well as optionally fillers, crosslinking agents and other auxiliary substances that improve the properties of the rubber wherein said quaterpolymers comprise
a) 40 to 95 wt. % of a conjugated diene,
b) 1 to 30 wt. % of a vinyl-substituted aromatic compound,
c) 1 to 30 wt. % of an olefinically unsaturated nitrile, and
d) 0.1 to 20 wt. % of a vinyl monomer containing hydroxyl groups or epoxy groups,
wherein the components a) to d) in each case total 100 wt. %.

5. Rubber molded parts containing rubber mixtures comprising quaterpolymers and other natural or synthetic rubbers or mixtures of natural or synthetic rubbers as well as optionally fillers, crosslinking agents and other auxiliary substances that improve the properties of the rubber wherein said quaterpolymers comprise
a) 40 to 95 wt. % of a conjugated diene,
b) 1 to 30 wt. % of a vinyl-substituted aromatic compound,
c) 1 to 30 wt. % of an olefinically unsaturated nitrile, and
d) 0.1 to 20 wt. % of a vinyl monomer containing hydroxyl groups or epoxy groups,
wherein the components a) to d) in each case total 100 wt. %.
wherein said rubber mixture undergoes a shaping process by vulcanization.
